(19) United States
(12) Patent Application Publication
(10) Pub. No.: US 2012/0038820 A1
(43) Pub. Date: Feb. 16, 2012

(54) Rapid Test Quantitative Reader

(76) Inventor: GANGASWAMY KEMPAHONNAIAH, Valley Center, CA (US)

(21) Appl. No.: 12/856,803

(22) Filed: Aug. 16, 2010

(51) Int. Cl. H04N 5/225; G06K 9/62

(52) U.S. Cl. 348/370; 382/165; 348/E05.024

(57) ABSTRACT

This invention is about an apparatus, capable of capturing and processing images for patterns and tags. Images obtained by using this invention will be analyzed for the tag recognition. Once tag is recognized corresponding image pattern recognition algorithm is applied to determine the validity and measure of the captured image. The measure is used to determine the quantitative results of a diagnostic test. The quantitative results are determined based on the average image pixel strength of pattern area. Pixel strength is determined based on red, blue and green color component of the pixel and also brightness, hue, saturation, gamma, and contrast. This invention includes specific devices designed to capture the object images, algorithms, procedures and methods used to process images to determine the corresponding quantitative measure. The objects included in the present invention are rapid test kits.

### BACKGROUND OF THE INVENTION

1. Field of the Invention

The present invention relates to medical diagnostics and, more specifically, to rapid test kits

2. Description of the Related Art

Some forms of medical diagnostic, such as microbial or hormonal concentration or chemical concentrations in blood, serum, saliva and urine, involve the reaction to agents by exposing them for given period of time and physical process such osmosis, centrifugal or centripetal revolutions. Thus changes on the sample recorded and measured using laboratory test tubes. This process is been carried out for centuries and more advanced bio-medical devices are developed to automate this procedure. These solutions are very expensive and time consuming and also lead to inaccuracies if error happens.

Some forms of devices existing in the market perform the similar objective are limited in the physical design perspective and inability to adapt to the new diagnostic patterns coming to the market and inability to program the new pattern. These devices designed at firmware level it is difficult to keep up with the fast faced technological advances and hence soon incompatible and outdated. Some of the devices are expensive and unable to provide accurate readings. Due to inability and low tolerance for the input error, readings were inaccurate more often.

Some systems were designed for totally different setup and purpose and later fine-tuned to address this fast moving rapid test kits were inefficient. By this kind of device suffer from economic and compact design. These models are bulky and inefficient. Software user interface is clumsy or unusable in most part and hence these systems pose the challenge to the consumer to train their work force.

### BRIEF SUMMARY OF THE INVENTION

It is therefore a principal object and advantage of the present invention to provide that may accurately determine the target pattern and provide accurate quantitative results.

It is another object and advantage of the present invention to provide flexibility for the user to use different rapid kits to analyze and process the patterns such as having multiple confirmation lines or multiple test lines.

It is a further object and advantage of the present invention to provide flexibility in physical design which allows multiple objects can be imaged using adaptive tray containers.

In accordance with the foregoing objects and advantages, the present invention provides a clinical sampling system comprising a conventional test strip having a confirmation or reference region, test region to determine the results and a sample region that is exposed to a sample liquid such as blood, saliva, serum or urine, and then positioned in a reader having an optical imager that acquires an image of the object. The image of the object is then digitally processed and the results are interpreted to provide an indication of the relative amounts of target compounds, such as antibiotics, that may be present in the sample liquid.

### BRIEF DESCRIPTION OF THE DRAWINGS

The present invention will be more fully understood and appreciated by reading the following Detailed Description in conjunction with the accompanying drawings, in which:

FIG. 1 is perspective view of a system according to the present invention.

FIG. 2 is a open view of a system according to the present invention.

FIG. 3 is a perspective view of a tray according to the present invention.

FIG. 4 is a perspective view of a rapid test kit according to the present invention.

FIG. 5 is a schematic of this quantitative reader system for interconnection to a host device according to the present invention.

FIG. 6 is a high-level flowchart of an image interpretation process according to the present invention.

FIG. 7 is a high-level flowchart of an alternate step to tag image interpretation process according to the present invention.

FIG. 8 is an image of a confirmation line and test line according to the present invention.

FIG. 9 is a chart illustrating the pixel magnitude profile along the confirmation line and test according to the present invention.

FIGS. 10 through 13 are images of different embodiments of rapid test kits showing regions of interest according to the present invention.

### DETAILED DESCRIPTION OF THE INVENTION

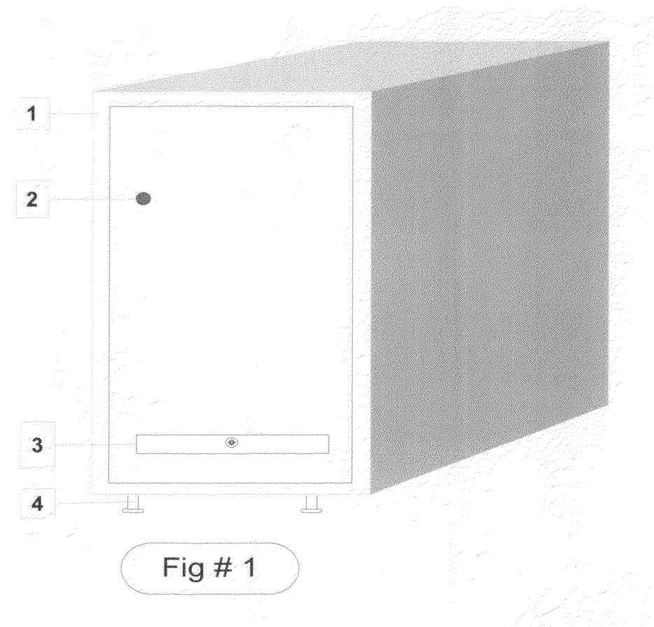

Referring now to the drawings, wherein like reference numerals refer to like parts throughout, there, is seen in FIG. 1 perspective view of a system according to the present invention. Part 1 is a sheet metal or AWS material enclosure. Part 2, is the LED (Light Emitting Diode) indicator shows whether system is on or off. Part 3, is the plastic tray used to hold the rapid test kits. Part 4 is the supporting bushes protect device and furniture from scratches while moving and handling the device.

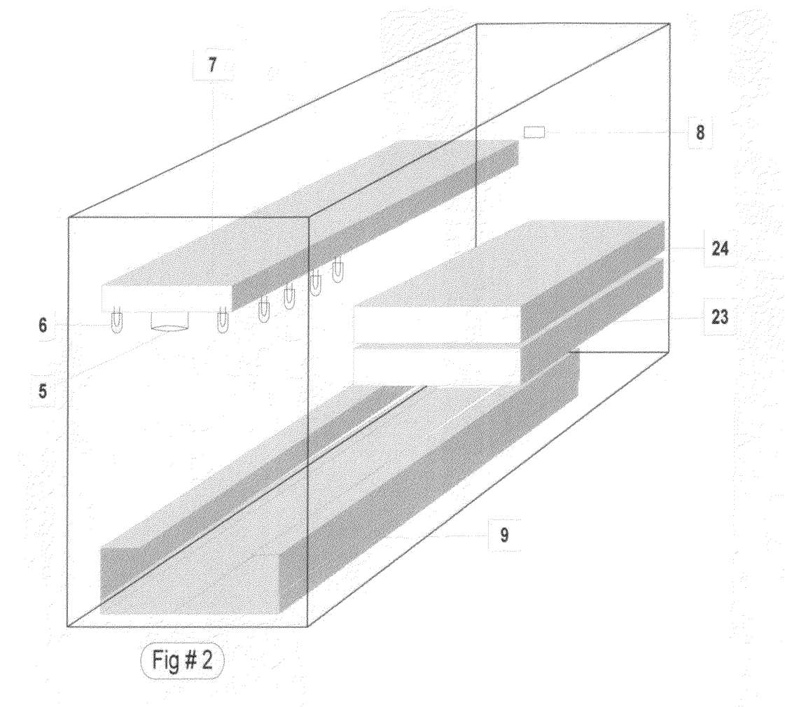

Referring to FIG. 2 is an open view of a system according to the present invention. Part 5 is lens used for image capture part of the digital camera housed and connected the part 7. Part 6 is the lighting source consists of array of ultraviolet LEDs and they are housed and connected to the part 7. These LEDs will lit when the device connected to the host device. They are arranged such that they provide even light on the object. Part 7 is the printed circuit board which consists of digital image sensor and integrated circuit capable of transferring the digital image to host device using USB (universal Serial Bus). However this transfer capability is not limited USB, it can be extended to RS232, IEEE, 802b, Bluetooth, Ethernet and Infrared communications. Part 8 has USB female type 2 port and is housed to part 7 and extended to outside where in it can be connected easily to the hosting device. Part 9 is the sliding slot holds tray and it designed to conveniently slide in & out from the enclosure and helps objects align accurately with the lens i.e., part 5. Part 23 is the barcode reader which recognizes the rapid test kit type based on the barcode pattern. Part 24 is the RFID reader which reads RFID tags affixed to the rapid test kit. Part 23 and part 24 it self are not part of this invention and these are other patented or commercially available OEM products.

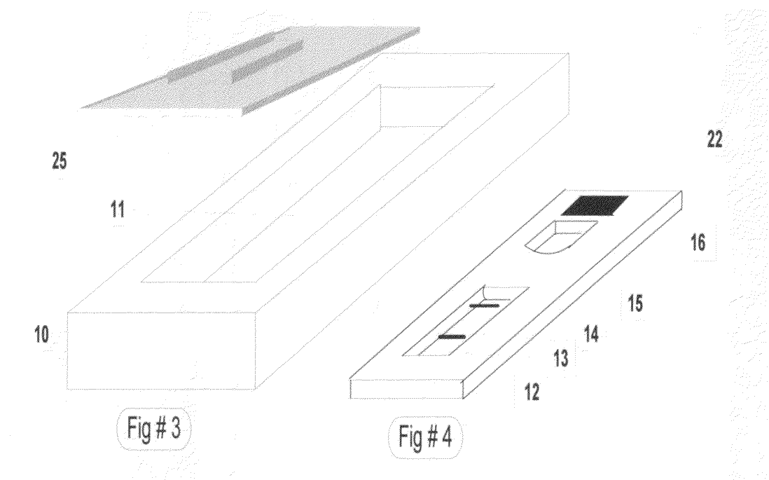

Referring to FIG. 3 is a perspective view of a tray according to the present invention. This provides the housing for the rapid test kits. Rapid test kit s comes in various sizes and this tray helps them align properly to camera (FIG. 2 part 5.). Tray comes various housing mini trays (part 25) which can accommodate single strip to multi strip rapid test kits. Part 10 is frame to the tray and it is strong and holds mini trays. Part 11 is the slot or grove made to place mini trays on the main tray.

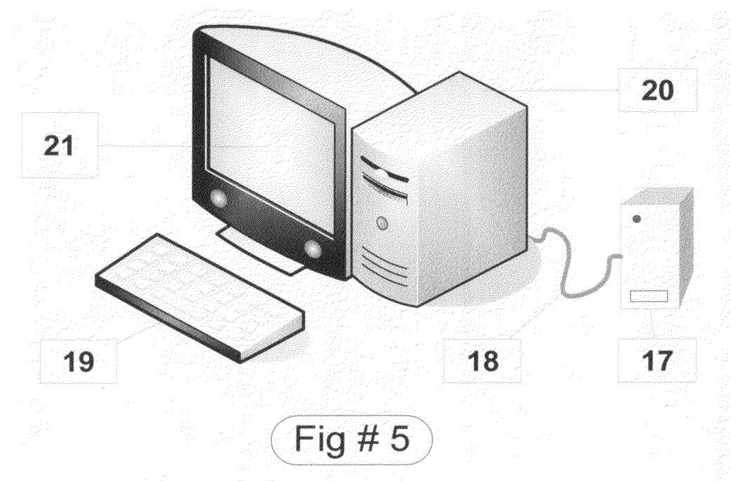

As shown in FIG. 4 is a perspective view of a rapid test kit according to the present invention. This rapid kit design and functionality is not part of this invention. This is shown to demonstrate the functionality of this device invention. The rapid test kits perform vital functionality in medical diagnosis. Part 22 is the tag information either this information is bar coded or plain printed text or RFID tag affixed or housed inside rapid test kit. Part 12 is the rapid test kit body which houses lateral flow strip with two openings one for confirmation and test line region and other one for the sampling region. Part 13 shows the Confirmation line and Test line section. Part 14 is the confirmation line region and part 15 is the Test line region. These lines can one or multiple. Part 16 the sampling region where liquid sample such as blood, serum, saliva or urine is dropped and waited for specified time to form the control line and test lines. Given rapid test kit can contain more than one sampling section and test confirmation section. These rapid test kits will be placed in to the mini trays and mini trays placed in the main tray and then slide in to the apparatus.

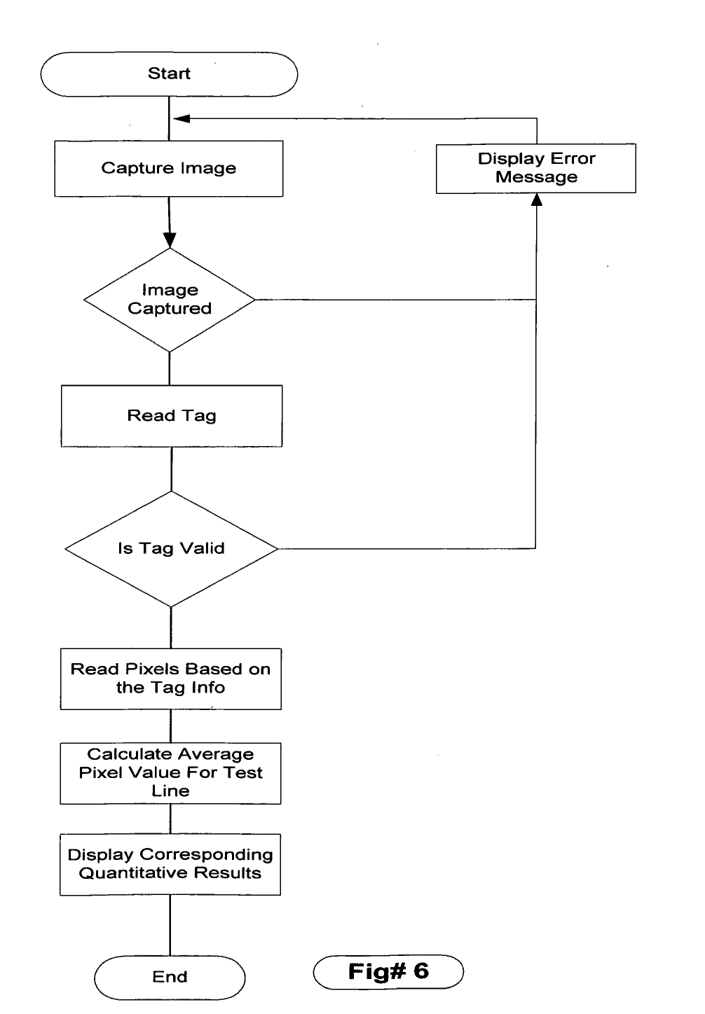

Referring to FIG. 5 is a schematic of this invention (quantitative reader) system for interconnection to a host device according to the present invention. Part 17 is the invention related device. Part 18 is the connecting media to the hosting device. The current invention involves USB 2.0 cable however it is not limited to the USB and it can extend to IEEE, 1392, Bluetooth, 802.11b, infrared (IrDA), PCMCIA, RS 232 and Ethernet (TCP/IP). Part 19 is any key board used enters data to the computer either integrated with computer such as laptop or tablet computer. Part 20 is computer includes CPU and which can process the information. Computer includes Personal computers, Servers, Laptops, desktops and tablets and running windows operating system. Part 21 is monitor, includes touch screen, LCD, CRT and plasma. Host device runs current invention software to interact with current invention device.

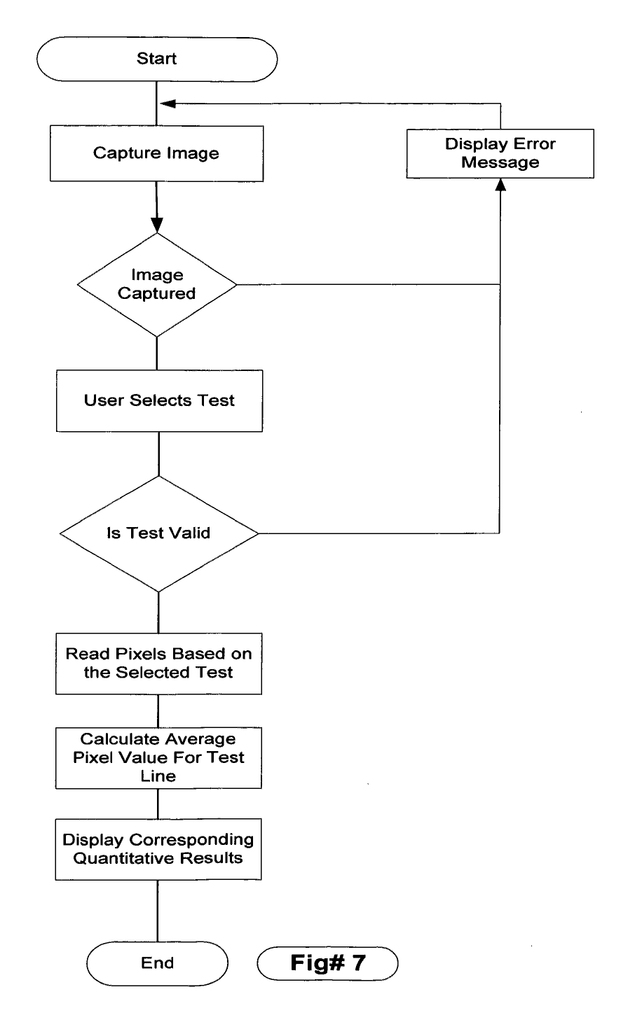

Referring FIG. 6 is a high-level flowchart of an image interpretation process according to the present invention. Flowchart provides very high level details on the main functionality of the software. Software uses manually calibrated values in the database for the each test and corresponding pixel patterns and their average values and corresponding quantitative values. Upon program start software provides user capability or menu option to capture object image and software analyses it for validity and then proceeds to determine the tag value. Software is designed to read tags in three different ways, either by RFID or barcode or user can select the tag value (tag value is coded unique test identifier) and based on the tag value software determines the region of image needs to be analyzed and parses each pixel in that area and finds average pixel strength by adding RGB (Red Green & Blue) component, brightness, contrast, hue, saturation, alpha and gamma values. After computing the test region pixel strength will be compared against the stored value for that tag that gives actual quantitative value. Software displays this value to the user and also stores for the future purposes. Software also provides user capability to add patient info and associate patient with the test results. Software also provides the reporting & printing capability so that overall operation automated and determining the results are simplified and improved accuracy from user errors.

Referring to FIG. 7 is a high-level flowchart of an alternate step to image interpretation process according to the present invention. This same as paragraph [0027] except the software provides the user option to select the tag values from application graphics user interface where RFID or barcode options are not available.

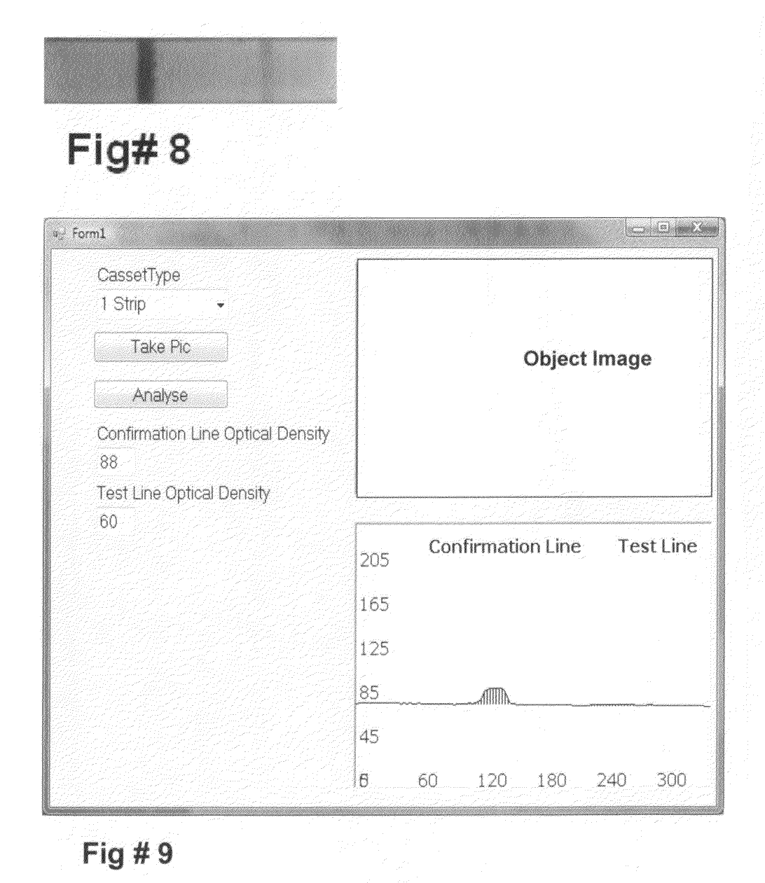

Referring to FIG. 8 is an image of enhanced section of confirmation line and test line area. This is the area of importance for this invention and which provides visual composition to determine the quantitative value. These confirmation and test line areas varies for each rapid test kits since these kits available in various sizes and various of counts of sections such six different confirmation and test line areas on single rapid test kit. Rapid test kits also have multiple confirmation lines and test lines.

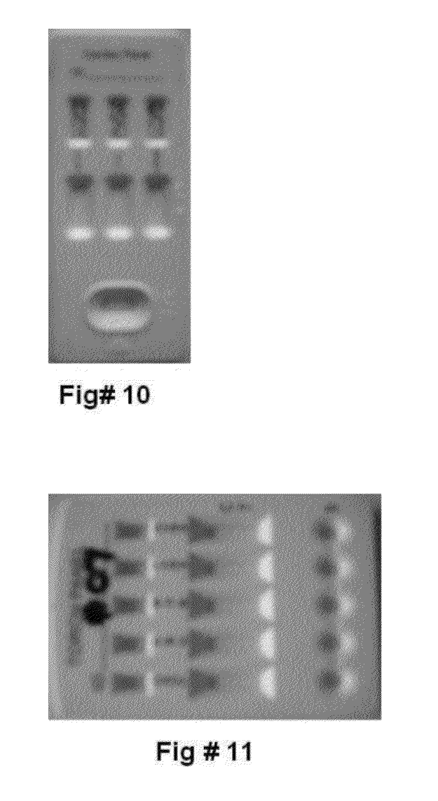

Referring to FIG. 9 is a chart showing the confirmation line and test line concentration in graphical line chart. This line chart is drawn in correspondence to the pixel strength of the confirmation line and test line. Software also marks the area shaded for clear visibility and also displays actual associated quantitative number.

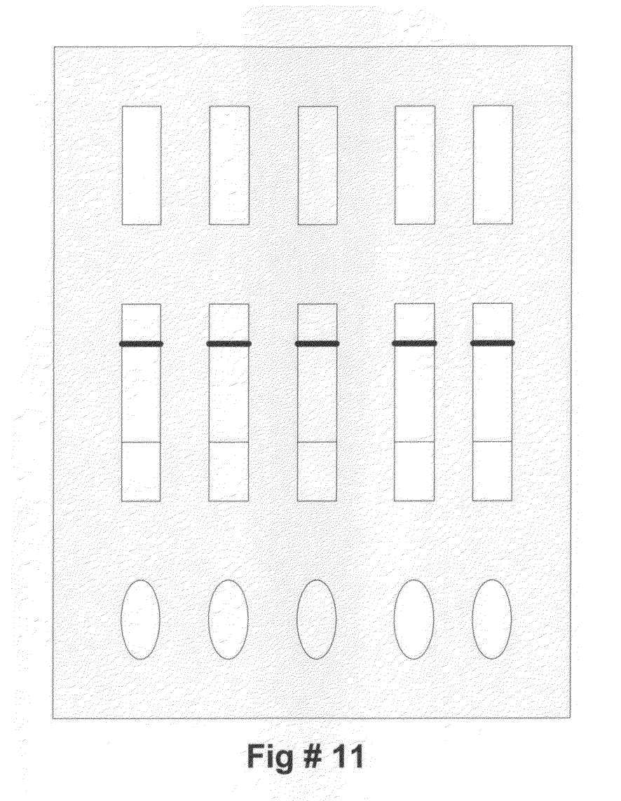

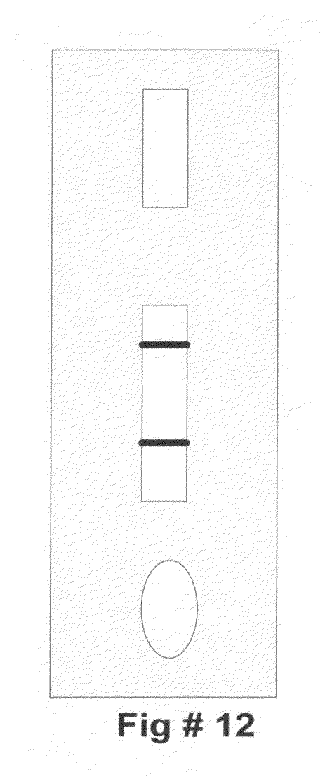

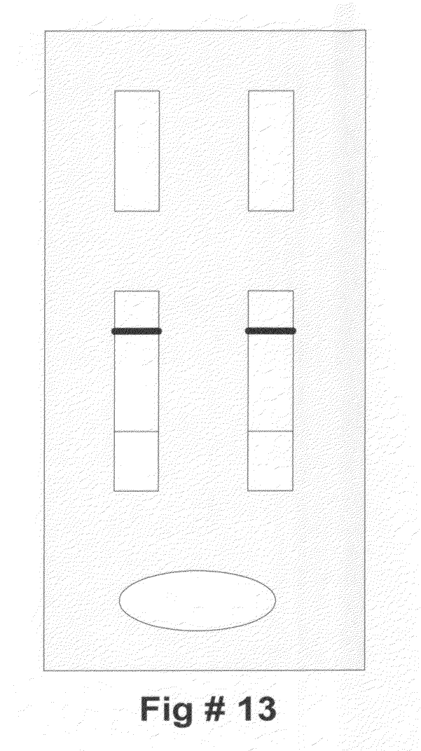

Referring to FIG. 10, 11, 12, are few examples of rapid test kits.

### Tables

Sample Mapping of Quantitative Results to Pixel Strength

| Compound Name | Test Type | Unit | Quantitative | Pixel Strength |
|---|---|---|---|---|
| THC | Quantitative | ng | 2 | 61.24 |
| TNI | Quantitative | mg | 1 | 63.32 |
| HBSag | Quantitative | ng | 4 | 67.54 |

Concentration of compound may vary in levels. To simplify the overall reading at nano-gram level grouped into five to ten ranges. However this range is flexible and numbers can go much numeral as we may need. The below table provides sample concentration levels and mappings to the pixel strength

| Compound Name | Test Type | Unit | Quantitative | Pixel Strength |
|---|---|---|---|---|
| THC | Quantitative | ng | 2 | 61.24 |
| THC | Quantitative | ng | 4 | 63.32 |
| THC | Quantitative | ng | 8 | 67.54 |
| THC | Quantitative | ng | 16 | 69.54 |
| THC | Quantitative | ng | 32 | 72.54 |

### Formulas & Algorithm

Test Line area are added by pixel lines and divided by total pixel lines.

Test Line Pixel Strength=(sum of each pixel lines falls on test line)/total number of pixels lines;

### Algorithm:

Pixels are stored in two dimensional arrays for an image in digital systems. Let say in Cartesian co ordinate system “x” axis represents the width of the image and ‘Y’ axis represents height of the image. To calculate Test line pixel strength algorithm is written as follows.

Ave=0;
For ( int x=xtbegin; x<=xtend; x++;)
{

For (int y=ytbegin; y<=ytend;y++;)

{

pixel = image.GetPixel(x,y);
Ave = ave+

pixel.R.Value( )+pixel.G.Value( )+pixel.B.Value( )+pixel.Hue( )+pixel.Brightne
ss( )+pixel.Contrast( )+pixel.Alpha( )+pixel.Saturation( );
}

}
Ave = Ave / (xtend−xtbegin);

Applications of this Invention

Some of the applications not limited the below list

This invention can be used to determine quantitative results based on the optical density.

Example application includes diabetes, heart problems, drug abuse, malaria, HIV etc.

This invention can be used to measure quantitative results in animal deceases

This invention can be used in R&D Developments to measure accurate quantitative results.

This invention can be used medical diagnostic clinics, Doctors office, patients home to measure quick results of the sample in inexpensive way.

### Operating Steps

Wear clean gloves and collect sample such as blood, serum or urine.

Choose appropriate Rapid Test Kit.

Apply or drop sample on the rapid test kit at sample area.

Wait for specified time (usually 5 minutes) as provided in the rapid test kit instruction leaflet.

Once confirmation line forms place the rapid test kit in the appropriate mini tray

Place mini tray into the main tray

Push/slide main tray into the reader

Start the program/application by clicking the icon created at the desktop.

Enter username and password to login

Select new test and Click on the Test Name/Tag

Click Capture Image

Click on analyze image

Application (this invention) displays Confirmation line and test line chart and appropriate quantitative number is the list.

By Clicking Save button Analysis can be saved or printed for the reference.

1. An apparatus for capturing an object image, comprising: a housing having a sliding slot formed therein; tray to hold an object; a object adapted for placement into tray; and an optical imaging unit (camera interconnected with computer), lighting source, barcode reader, RFID reader, indicator and reflective mirrors to obtain shadow free images positioned with said housing to capture images of said objects when inserted into said slot.

2. The software application to operate current invention, wherein said computer is programmed to capture the image and process tag information and recognizes the preprogrammed pattern matching to the tag. Once tag is recognized then corresponding pattern recognition algorithm is used to determine the object specific details. These details include region of the image, color of the image and color concentration and pattern of the image such scattered dots, bars, lines and patches. Based on these patterns, algorithm provides both qualitative and quantitative analysis and results.
